(19) United States
(12) Patent Application Publication
(10) Pub. No.: US 2025/0246849 A1
(43) Pub. Date: Jul. 31, 2025

(54) COVER-EQUIPPED CONNECTOR

(71) Applicant: SUMITOMO WIRING SYSTEMS, LTD., Mie (JP)

(72) Inventor: Kuniaki TANIDA, Mie (JP)

(21) Appl. No.: 19/021,961

(22) Filed: Jan. 15, 2025

(30) Foreign Application Priority Data
Jan. 25, 2024 (JP) 2024-009240

(51) Int. Cl. H01R 13/58

(52) U.S. Cl. CPC H01R 13/5812

(57) ABSTRACT

A cover-equipped connector 10 includes a terminal fitting 11 connected to an end part of a wire 14, a housing 20 for accommodating the terminal fitting 11 and a cover 40 to be mounted on the housing 20. The cover 40 includes a wire accommodating portion 42 arranged behind the housing 20. The wire accommodating portion 42 holds the wire 14 pulled out rearward from the housing 20 in a laterally bent state by pressing the wire 14 between the housing 20 and the wire accommodating portion 42. At least either one of the housing 20 and the cover 40 includes rattling preventing portions 44A, 44B for filling a gap between the housing 20 and the cover 40.

### CROSS-REFERENCE TO RELATED APPLICATIONS

This application is based on and claims priority from Japanese Patent Application No. 2024-009240, filed on Jan. 25, 2024, with the Japan Patent Office, the disclosure of which is incorporated herein in its entirety by reference.

### TECHNICAL FIELD

The present disclosure relates to a cover-equipped connector.

### BACKGROUND

Conventionally, a cover-equipped connector provided with a connector and a cover is known as described in Japanese Patent Laid-open Publication Nos. 2020-126713, H11-067332, 2010-092663 and 2013-110025. The connector includes a terminal fitting connected to an end part of a wire and a housing for accommodating the terminal fitting, and the cover is mounted on a rear side of the housing. A cover-equipped connector in which a wire pulled out rearward from a housing is inserted into a corrugated tube and the wire and the corrugated tube are bent by a connector cover is described in Japanese Patent Laid-open Publication No. 2020-126713.

### SUMMARY

There has been a demand for the cover-equipped connector as described above to make vibration caused by a swinging motion of the wire less likely to be transmitted to the terminal fitting in preparation for a case where the cover-equipped connector is placed in a severe vibration environment.

Accordingly, the present disclosure aims to provide a cover-equipped connector capable of making vibration caused by a swinging motion of a wire less likely to be transmitted to a terminal fitting.

The present disclosure is directed to a cover-equipped connector with a terminal fitting connected to an end part of a wire, a housing for accommodating the terminal fitting and a cover to be mounted on the housing, the cover including a wire accommodating portion arranged behind the housing, the wire accommodating portion holding the wire pulled out rearward from the housing in a laterally bent state by pressing the wire between the housing and the wire accommodating portion, and at least either one of the housing and the cover including rattling preventing portions for filling a gap between the housing and the cover.

According to the present disclosure, it is possible to provide a cover-equipped connector capable of making vibration caused by a swinging motion of a wire less likely to be transmitted to a terminal fitting.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector according to an embodiment.

FIG. 2 is a section showing the connector.

FIG. 3 is a perspective view showing a housing when viewed from front.

FIG. 4 is a perspective view showing the housing when viewed from behind.

FIG. 5 is a section of the connector showing a wire in a bent state.

FIG. 6 is an exploded perspective view showing a cover.

FIG. 7 is a front view showing the cover.

FIG. 8 is a plan view showing the connector.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The cover-equipped connector of the present disclosure is provided with a terminal fitting connected to an end part of a wire, a housing for accommodating the terminal fitting and a cover to be mounted on the housing, the cover including a wire accommodating portion arranged behind the housing, the wire accommodating portion holding the wire pulled out rearward from the housing in a laterally bent state by pressing the wire between the housing and the wire accommodating portion, and at least either one of the housing and the cover including rattling preventing portions for filling a gap between the housing and the cover. According to this configuration, a swinging motion of the wire is suppressed by the wire accommodating portion, and rattling between the housing and the cover is suppressed by the rattling preventing portions. Therefore, vibration caused by the swinging motion of the wire can be made less likely to be transmitted to the terminal fitting.
[2] In the cover-equipped connector of [1] described above, the cover may include a receptacle for covering an outer peripheral surface of the housing, and the rattling preventing portions may include a first rattling preventing portion for filling a gap between the outer peripheral surface of the housing and an inner peripheral surface of the receptacle. According to this configuration, ratting between the housing and the cover in a width direction or a height direction can be suppressed.
[3] In the cover-equipped connector of [1] or [2] described above, the cover may include a coupling portion coupling the receptacle and the wire accommodating portion, the coupling portion may include a cover facing portion facing a rear surface of the housing, and the rattling preventing portions may include a second rattling preventing portion for filling a gap between the rear surface of the housing and the cover facing portion. According to this configuration, ratting between the housing and the cover in a front-rear direction can be suppressed.
[4] In the cover-equipped connector of [3] described above, if the wire is bent upward, the second rattling preventing portion may be provided at least below a rear end opening of a cavity formed in the housing. According to this configuration, since the second rattling preventing portion is provided in a place where rattling easily occurs due to the swinging motion of the wire, rattling can be effectively prevented.
[5] In the cover-equipped connector of any one of [1] to [4] described above, the wires may be arranged side by side in a row, and the cover may include a partition wall partitioning between the wires adjacent in an arrangement direction. According to this configuration, the wires arranged side by side in a row can be partitioned in the cover, and the wires can be held in an individually bent state.

### Details of Embodiment of Present Disclosure

A specific example of a cover-equipped connector of the present disclosure is described below with reference to the drawings. Note that the present invention is not limited to these illustrations, but is represented by claims and intended to include all changes in the scope of claims and in the meaning and scope of equivalents.

### EMBODIMENT

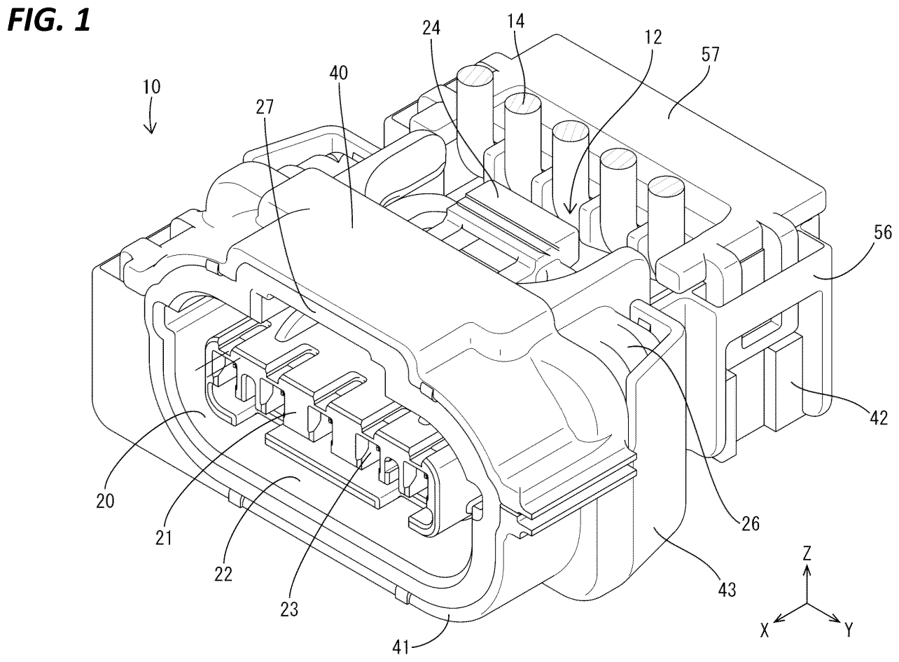

A cover-equipped connector is connected to end parts of wires 14 as shown in FIG. 1. Hereinafter, the cover-equipped connector is merely referred to as a connector 10. The connector 10 is connectable to an unillustrated mating connector.

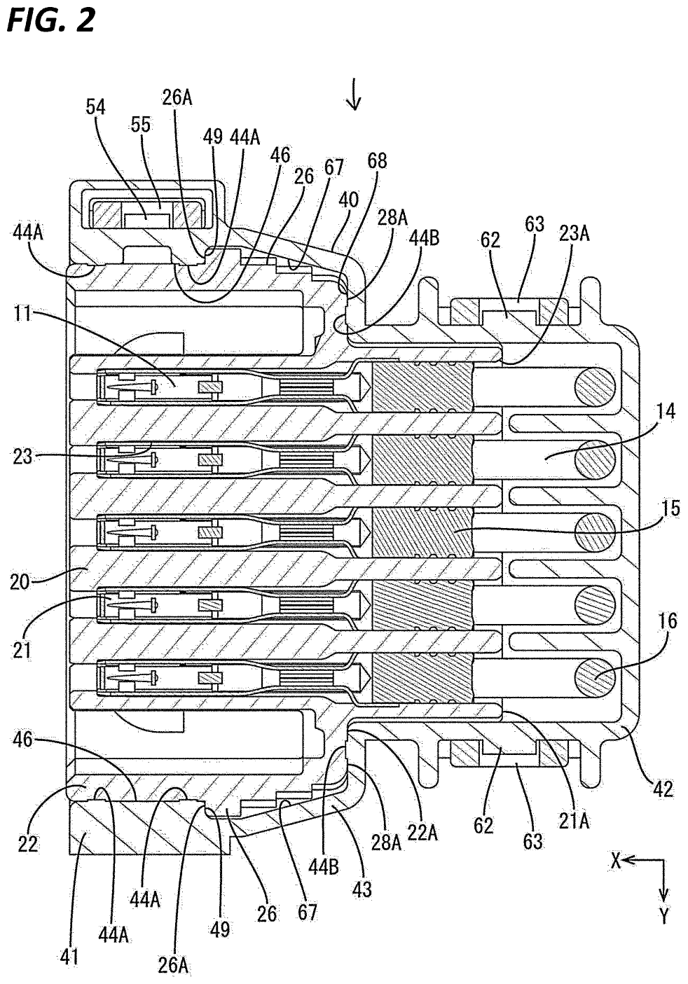

The connector 10 is provided with a plurality of terminal fittings 11, a housing 20 and a cover 40 as shown in FIG. 2. Each terminal fitting 11 is connected to the end part of the wire 14. The housing 20 accommodates the plurality of terminal fittings 11. The cover 40 is mounted on the housing 20. The cover 40 protects the housing 20 and determines a pull-out direction of the wires 14.

Hereinafter, each constituent member is described, assuming that a connection direction to the mating connector is a forward direction and the pull-out direction of the wires 14 from the connector 10 is an upward direction. In each figure, a positive direction of an X axis is the forward direction, a positive direction of a Y axis is a leftward direction and a positive direction of a Z axis is the upward direction.

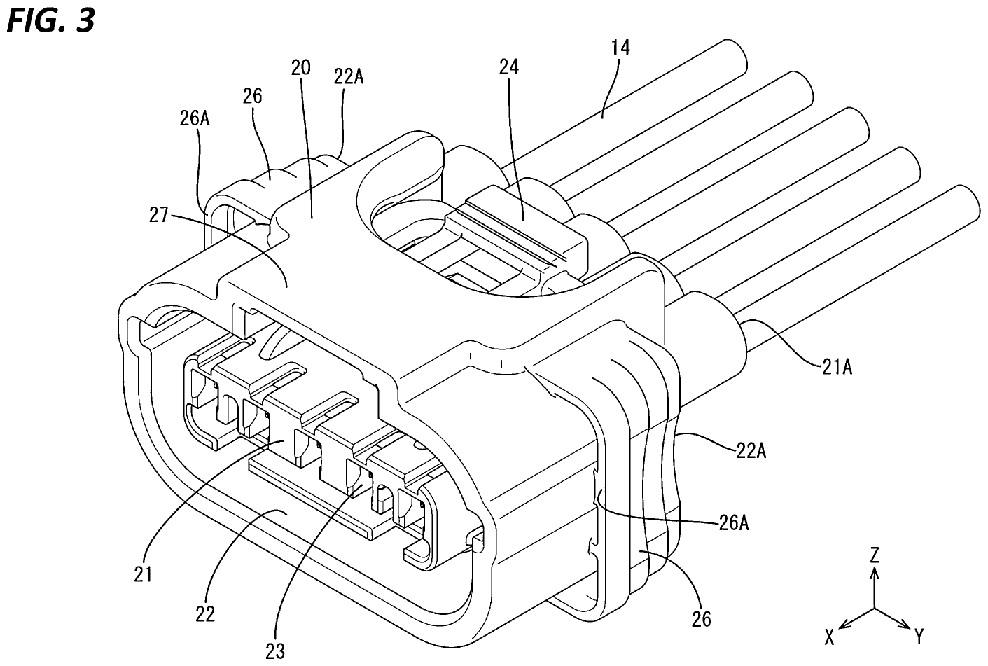

The housing 20 is made of synthetic resin and integrally includes a terminal accommodating portion 21 and a fitting portion 22 as shown in FIGS. 2 and 3. A plurality of cavities 23 are provided side by side in a row in a lateral direction in the terminal accommodating portion 21. The terminal fitting 11 is inserted and accommodated into each cavity 23 from behind.

A lock arm 24 is provided in a lateral central part of the upper surface of the terminal accommodating portion 21. The lock arm 24 locks the mating connector and holds the mating connector and the connector 10 in a connected state.

As shown in FIG. 3, the fitting portion 22 has a tubular shape. The fitting portion 22 surrounds the outer periphery of the terminal accommodating portion 21. The mating connector is fittable into the inside of the fitting portion 22 from front. A bulging portion 27 is provided on the upper surface of the fitting portion 22. The bulging portion 27 protects the lock arm 24. Further, the bulging portion 27 bulges upward.

The fitting portion 22 includes protruding portions 26. The protruding portions 26 are provided on both left and right sides of the fitting portion 22. The protruding portions 26 are provided on a rear part of the fitting portion 22. The protruding portions 26 project further outward than a front part of the fitting portion 22. Front surfaces 26A of the protruding portions 26 butt against step surfaces 49 of the cover 40 to be described later from behind.

Each protruding portion 26 is provided to extend in the vertical direction from the upper end to the lower end of the fitting portion 22. The upper end of each protruding portion 26 is arranged at the position of the bulging portion 27 in the vertical direction. The laterally outer side surface of the protruding portion 26 is stepped in the absence of the cover 40 as shown in FIG. 2 and easily hand-gripped. The laterally outer side surface of the protruding portion 26 protrudes gradually laterally outward from a rear side toward a front side.

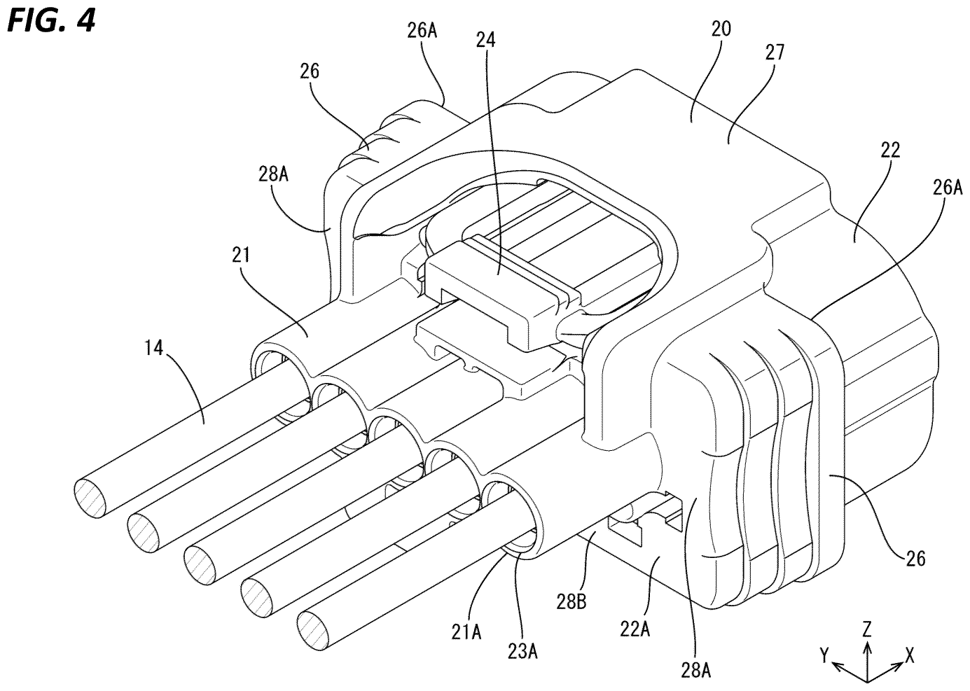

A rear surface 22A of the fitting portion 22 projects toward an outer peripheral side from an intermediate position in a front-rear direction of the terminal accommodating portion 21 as shown in FIG. 4. The rear surface 22A of the fitting portion 22 is equivalent to the rear surface of the housing 20. The rear surface 22A of the fitting portion 22 is parallel to a YZ plane. The rear surface 22A of the fitting portion 22 includes left and right rear surface side parts 28A and a rear surface lower part 28B. The rear surface side parts 28A are located on both left and right sides of the terminal accommodating portion 21. Each rear surface side part 28A is continuous from the upper end to the lower end of the protruding portion 26. The rear surface lower part 28B is located bellow the terminal accommodating portion 21. The rear surface lower part 28B extends in the lateral direction between lower end parts of the left and right rear surface side parts 28.

As shown in FIG. 2, a rubber plug 15 is mounted on the outer peripheral surface of each wire 14. The rubber plug 15 is held in close contact with the inner peripheral surface of each cavity 23 and individually seals each cavity 23. Each wire 14 is pulled out rearward from a rear end 21A of the terminal accommodating portion 21. The wires 14 pulled out from the terminal accommodating portion 21 are arranged side by side in a row in the lateral direction.

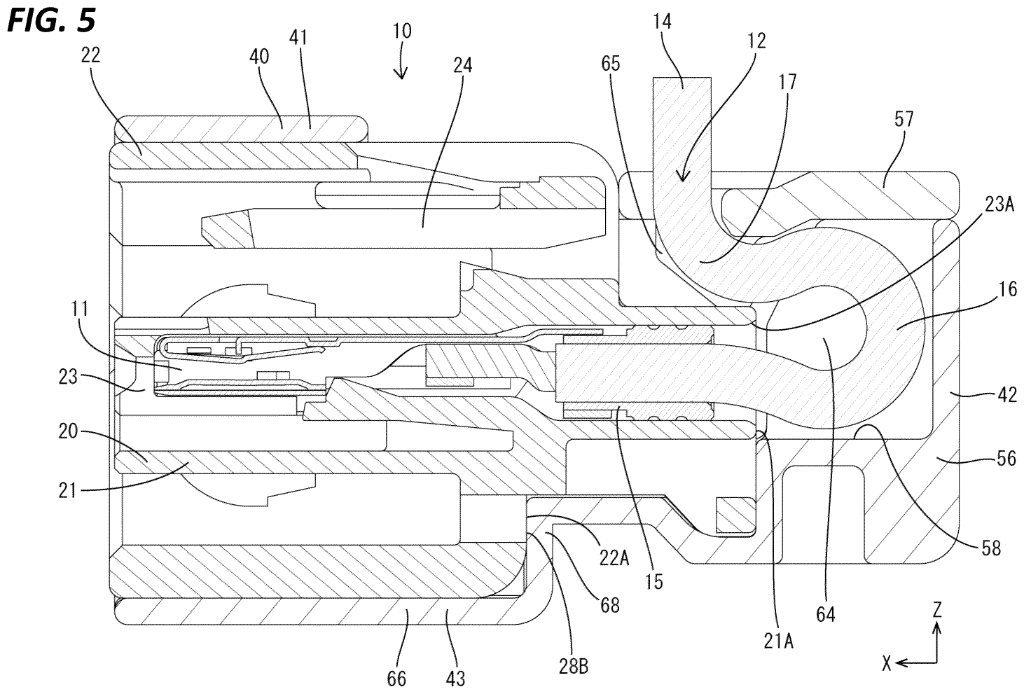

As shown in FIG. 5, each wire 14 is held in a state bent upward by a wire pressing portion 57 to be described later. Each wire 14 includes a first bent portion 16 and a second bent portion 17. The first and second bent portions 16, 17 are both arranged in the cover 40.

The first bent portion 16 is U-shaped by being folded from the rear side toward the front side. The second bent portion 17 is bent upward substantially at a right angle. A part of each wire 14 beyond the second bent portion 17 is pulled out upward from a wire pull-out opening 12.

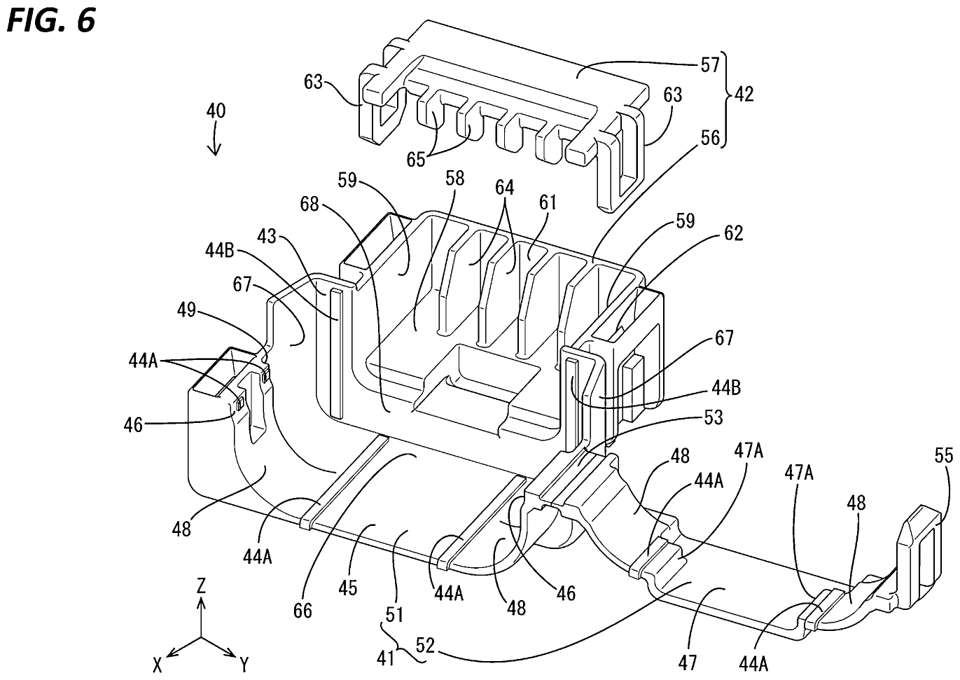

The cover 40 is made of synthetic resin. As shown in FIGS. 5 and 6, the cover 40 integrally includes, as one component, a receptacle 41, a wire accommodating portion 42, a coupling portion 43, first rattling preventing portions 44A and second rattling preventing portions 44B. The receptacle 41 covers the outer peripheral surface of the fitting portion 22. The wire accommodating portion 42 accommodates the wires 14 pulled out from the housing 20. The coupling portion 43 couples the receptacle 41 and the wire accommodating portion 42.

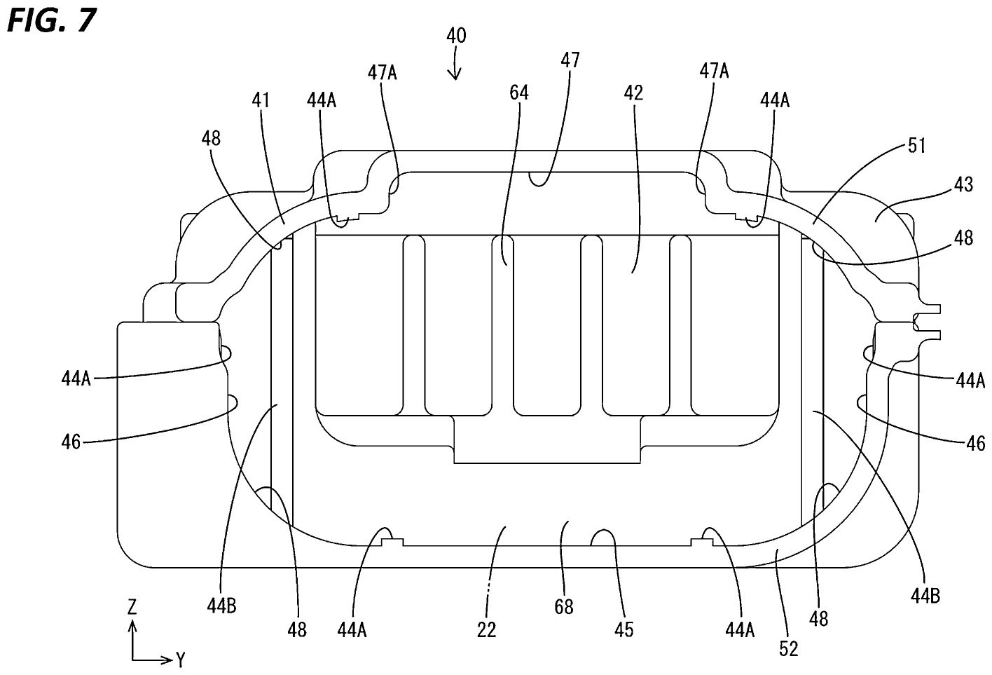

As shown in FIG. 7, the inner peripheral surface of the receptacle 41 is shaped along the outer peripheral surface of the fitting portion 22. The inner peripheral surface of the receptacle 41 has a lower surface part 45, left and right side surface parts 46, an upper surface part 47 and curved surface parts 48. The lower surface part 45 is formed in a lateral central part of the receptacle 41. The lower surface part 45 is parallel to an XY plane. The left and right side surface parts 46 are formed on both sides in the lateral direction of the receptacle 41. The left and right side surface parts 46 are parallel to an XZ plane. The upper surface part 47 is formed at a position recessed upward in the lateral central part of the receptacle 41. The upper surface part 47 is parallel to an XY plane. Steps 47A are formed on both left and right ends of the upper surface part 47. The curved surface parts 48 are formed on upper, lower, left and right corner parts of the inner peripheral surface of the receptacle 41. Each curved surface part 48 has an arcuate shape when viewed from front. The upper curved surface parts 48 extend downward from the lower ends of the steps 47A. The lower curved surface parts 48 extend upward from both left and right ends of the lower surface part 45.

As shown in FIG. 6, the receptacle 41 includes a lower part 51 and an upper part 52. The lower and upper parts 51, 52 are divided at the positions of the left and right side surface parts 46. The lower and upper parts 51, 52 are coupled by a hinge 53. The hinge 53 couples the lower and upper parts 51, 52 so that the upper part 52 can be opened and closed with respect to the lower part 51. The lower part 51 is open so that the housing 20 can be placed from above.

The lower and upper parts 51, 52 are held in a closed state by a lock. The lock includes a lock projection 54 and a lock piece 55 (see FIG. 2). The lock projection 54 is provided on the lower part 51, and the lock piece 55 is provided on the upper part 52. The lock projection 54 and the lock piece 55 are locked to each other with the lower and upper parts 51, 52 closed.

As shown in FIG. 6, the wire accommodating portion 42 is provided behind the receptacle 41. The wire accommodating portion 42 includes a body portion 56 and the wire pressing portion 57. The body portion 56 includes a bottom wall portion 58, left and right side wall portions 59 and a rear wall portion 61. The bottom wall portion 58 is located slightly below rear end openings 23A of the cavities 23 (see FIG. 5). The left and right side wall portions 59 rise upward from both left and right ends of the bottom wall portion 58. The rear wall portion 61 rises upward from the rear end of the bottom wall portion 58.

The wire pressing portion 57 is mounted on the upper surface of the body portion 56. The wire pressing portion 57 is configured as a lid for closing the body portion 56 from above. The wire pressing portion 57 is in the form of a substantially rectangular plate long in the lateral direction. The wire pressing portion 57 is put on the wires 14 folded forward (see FIG. 5).

As shown in FIG. 5, the wire pressing portion 57 holds the wires 14 pulled out rearward from the housing 20 in a state bent upward. The first bent portion 16 is pressed from above by the wire pressing portion 57. The second bent portion 17 is formed between the wire pressing portion 57 and the terminal accommodating portion 21. The second bent portion 17 is supported from behind by the rear wall portion 61.

The body portion 56 and the wire pressing portion 57 are held in a state closed by locking portions. The locking portion includes a locking projection 62 and a locking piece 63 (see FIG. 2). The locking projections 62 are provided on both left and right sides of the body portion 56, and the locking pieces 63 are provided on both left and right sides of the wire pressing portion 57. The locking projections 62 and the locking pieces 63 are locked to each other with the body portion 56 and the wire pressing portion 57 closed.

As shown in FIG. 6, the wire accommodating portion 42 includes a plurality of first partition walls 64 and a plurality of second partition walls 65. The first and second partition walls 64, 65 partition between the wires 14 adjacent in an arrangement direction. The first partition walls 64 are provided on the body portion 56. The first partition walls 64 rise upward from the bottom wall portion 58 of the body portion 56 to the upper end of the body portion 56. The first partition walls 65 project forward from the rear wall portion 61 of the wire accommodating portion 42. The first partition walls 64 define internal spaces of the body portion 56. The first bent portions 16 of the wires 14 are partitioned one by one by the first partition walls 64 (see FIG. 2).

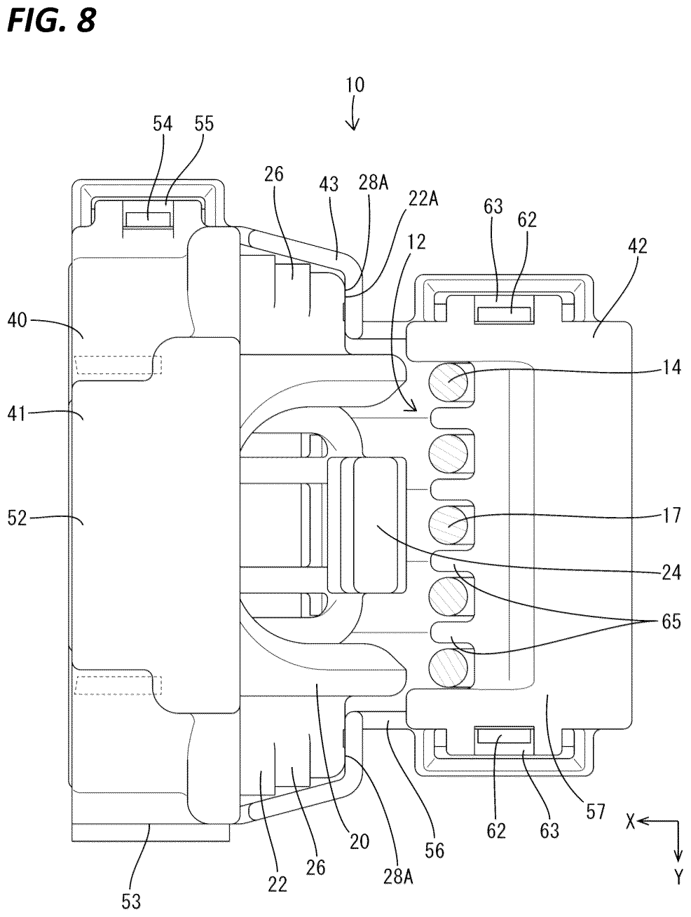

As shown in FIG. 6, the second partition walls 65 are provided on the wire pressing portion 57. The second partition walls 65 project forward from the front edge of the wire pressing portion 57. The second partition walls 65 extend downward from the wire pressing portion 57. The second partition walls 65 define the wire pull-out opening 12 as shown in FIG. 8. The second bent portions 17 of the wires 14 are separated one by one by the second partition walls 65.

As shown in FIG. 5, the wire pull-out opening 12 is formed between the wire pressing portion 57 and the fitting portion 22. The wire pull-out opening 12 is open upward. The wire pull-out opening 12 is elongated in the lateral direction as shown in FIG. 8.

As shown in FIG. 6, the coupling portion 43 couples the receptacle 41 and the wire accommodating portion 42. The coupling portion 43 is in the form of a box for accommodating a rear part of the fitting portion 22. The coupling portion 43 includes a lower surface part 66, left and right surface parts 67 and a rear surface part 68.

The lower surface part 66 and the left and right surface parts 67 are connected to the receptacle 41. Vertical dimensions of the left and right surface parts 67 are larger than that of the lower part 51 of the receptacle 41. The upper ends of the left and right surface parts 67 are located nearly at the same height as the upper end of the body portion 56 of the wire accommodating portion 42.

As shown in FIG. 2, the step surfaces 49 are formed between the left and right surface parts 67 of the coupling portion 43 and the left and right side surface parts 46 of the receptacle 41. The step surfaces 49 are surfaces parallel to a YZ plane. The step surfaces 49 extend in the vertical direction.

As shown in FIG. 6, the rear surface part 68 has plate surfaces parallel to a YZ plane. When viewed from front, the rear surface part 68 is U-shaped along the front edge of the body portion 56 of the wire accommodating portion 42. The rear surface part 68 is equivalent to a cover facing portion facing the rear surface 22A of the fitting portion 22. The upper end of the rear surface part 68 is located nearly at the same height as the upper end of the body portion 56 of the wire accommodating portion 42. The lower end of the rear surface part 68 is located nearly at the same height as the lower surface part 45 of the receptacle 41.

As shown in FIG. 7, the first rattling preventing portions 44A are provided on the receptacle 41. The first rattling preventing portions 44A are provided on upper, lower, left and right sides of the inner peripheral surface of the receptacle 41. The first rattling preventing portions 44A project inward from the inner peripheral surface of the receptacle 41.

A pair of the first rattling preventing portions 44A are provided on the lower surface part 45 of the receptacle 41. Each of the first rattling preventing portions 44A of the lower surface part 45 extends from the front end of the receptacle 41 to the rear end of the coupling portion 43 as shown in FIG. 6. The first rattling preventing portion 44A of the lower surface part 45 extends straight along a boundary with the curved surface part 48.

Two front and rear first rattling preventing portions 44A are provided on each of the left and right side surface parts 46 (see FIG. 2). The first rattling preventing portions 44A have the same shape and size on the left and right side surface parts 46.

As shown in FIG. 7, one first rattling preventing portion 44A is provided on each upper curved surface part 48. The first rattling preventing portions 44A of the upper curved surface parts 48 are arranged at positions near the upper surface part 47. Each of the first rattling preventing portions 44A of the upper curved surface parts 48 extends straight from the front end of the receptacle 41 to an intermediate position in the front-rear direction of the receptacle 41 as shown in FIG. 6.

The second rattling preventing portions 44B are provided on the rear surface part 68 of the coupling portion 43 as shown in FIG. 6. A pair of left and right second rattling preventing portions 44B are provided. The second rattling preventing portion 44B extends straight from the vicinity of the upper end to the lower end of the rear surface part 68. The lower end of the second rattling preventing portion 44B is located below the bottom wall portion 58 of the wire accommodating portion 42. The second rattling preventing portion 44B projects forward from the front surface of the rear surface part 68 as shown in FIG. 2.

With the cover 40 mounted on the housing 20, the protruding portions 26 of the housing 20 are accommodated in the coupling portion 43 as shown in FIG. 2. The front surfaces 26A of the protruding portions 26 are facing the step surfaces 49 of the cover 40 in the front-rear direction. In this way, the housing 20 is restricted from being separated forward from the cover 40. The rear surface 22A of the fitting portion 22 is facing the rear surface part 68 of the coupling portion 43 in the front-rear direction. The second rattling preventing portions 44B are in contact with the rear surface 22A of the fitting portion 22 to fill a gap in the front-rear direction between the rear surface 22A and the rear surface part 68. In this way, rattling between the housing 20 and the cover 40 in the front-rear direction is suppressed.

The fitting portion 22 of the housing 20 is covered by the receptacle 41 (see FIG. 7). The first rattling preventing portions 44A are in contact with the outer peripheral surface of the fitting portion 22 to fill a gap between the receptacle 41 and the fitting portion 22 in the vertical direction and the lateral direction. In this way, ratting between the housing 20 and the cover 40 in the vertical direction and the lateral direction is suppressed.

As shown in FIG. 5, each wire 14 is held in the state bent inside the wire accommodating portion 42, and pulled out upward from the wire pull-out opening 12. In this way, a swinging motion of the wire 14 is suppressed.

Next, functions and effects of the embodiment configured as described above are described. The connector 10 is provided with the terminal fittings 11, the housing 20 and the cover 40. The terminal fitting 11 is connected to the end part of the wire 14. The housing 20 accommodates the terminal fittings 11. The cover 40 is mounted on the housing 20. The cover 40 includes the wire accommodating portion 42. The wire accommodating portion 42 is arranged behind the housing 20. The wire accommodating portion 42 holds the wires 14 pulled out rearward from the housing 20 in the state bent upward by pressing the wires 14 between the housing 20 and the wire accommodating portion 42. The cover 40 includes the first and second rattling preventing portions 44A, 44B for filling the gaps between the housing 20 and the cover 40. According to this configuration, swinging motions of the wires 14 are suppressed by the wire accommodating portion 42, and rattling between the housing 20 and the cover 30 is suppressed by the first and second rattling preventing portions 44A, 44B. Therefore, vibration caused by the swinging motions of the wires 14 can be made less likely to be transmitted to the terminal fittings 11.

The cover 40 includes the receptacle 41 for covering the outer peripheral surface of the housing 20. The first rattling preventing portions 44A fill the gap between the outer peripheral surface of the housing 20 and the inner peripheral surface of the receptacle 41. According to this configuration, rattling between the housing 20 and the cover 40 in the lateral direction or vertical direction can be suppressed.

The cover 40 includes the coupling portion 43 coupling the receptacle 41 and the wire accommodating portion 42. The coupling portion 43 has the rear surface part 68 facing the rear surface 22A of the fitting portion 22. The second rattling preventing portions 44B fill the gap between the rear surface 22A of the fitting portion 22 and the rear surface part 68. According to this configuration, rattling between the housing 20 and the cover 40 in the front-rear direction can be suppressed.

The second rattling preventing portions 44B extend below the rear end openings 23 of the cavities 23 formed in the housing 20. According to this configuration, since the second rattling preventing portions 44B are provided in places where rattling easily occurs due to the swinging motions of the wires 14, rattling can be effectively prevented.

The wires 14 are arranged side by side in a row. The cover 40 includes the first and second partition walls 64, 65 partitioning between the wires 14 adjacent in the arrangement direction. According to this configuration, the wires 14 arranged side by side in a row can be partitioned in the cover 40 and the wires 14 can be held in the individually bent state.

### Other Embodiments of Present Disclosure

The embodiment disclosed this time should be considered illustrative in all aspects, rather than restrictive.

Although the cavities 23 arranged in a row in the lateral direction are provided only in one stage in the case of the above embodiment, cavities arranged in a row in the lateral direction may be provided in two or more stages in the vertical direction as another embodiment.

Although the first and second rattling preventing portions 44A, 44B are provided on the cover 40 in the case of the above embodiment, rattling preventing portions may be provided on a housing or may be provided on both a cover and the housing as another embodiment.

Although the connector 10 includes the first and second rattling preventing portions 44A, 44B in the case of the above embodiment, a connector may include only either first rattling preventing portions or second rattling preventing portions as another embodiment.

Although the wires are pulled out upward from the connector 10 in the case of the above embodiment, wires may be pulled out in any of leftward, rightward and downward directions as another embodiment.

Although the second rattling preventing portions 44B are formed on parts of the rear surface part 68 facing the rear surface side parts 28A in the case of the above embodiment, second rattling preventing portions may be formed in a part of a rear surface part facing a rear surface lower part as another embodiment.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A cover-equipped connector, comprising:
a terminal fitting connected to an end part of a wire;
a housing for accommodating the terminal fitting; and
a cover to be mounted on the housing,
the cover including a wire accommodating portion arranged behind the housing,
the wire accommodating portion holding the wire pulled out rearward from the housing in a laterally bent state by pressing the wire between the housing and the wire accommodating portion, and
at least either one of the housing and the cover including rattling preventing portions for filling a gap between the housing and the cover.

2. The cover-equipped connector of claim 1, wherein:
the cover includes a receptacle for covering an outer peripheral surface of the housing, and
the rattling preventing portions include a first rattling preventing portion for filling a gap between the outer peripheral surface of the housing and an inner peripheral surface of the receptacle.

3. The cover-equipped connector of claim 2, wherein:
the cover includes a coupling portion coupling the receptacle and the wire accommodating portion,
the coupling portion includes a cover facing portion facing a rear surface of the housing, and
the rattling preventing portions include a second rattling preventing portion for filling a gap between the rear surface of the housing and the cover facing portion.

4. The cover-equipped connector of claim 3, wherein, if the wire is bent upward, the second rattling preventing portion is provided at least below a rear end opening of a cavity formed in the housing.

5. The cover-equipped connector of claim 1, wherein:
the wires are arranged side by side in a row, and
the cover includes a partition wall partitioning between the wires adjacent in an arrangement direction.
